(19) United States
(12) Patent Application Publication
(10) Pub. No.: US 2023/0010781 A1
(43) Pub. Date: Jan. 12, 2023

(54) REDUCING TIME TO TEST CYCLE FIRST FAIL

(71) Applicant: Harness Inc., San Francisco, CA (US)

(72) Inventors: Shivakumar Ningappa, Milpitas, CA (US); Uri Scheiner, Pleasanton, CA (US); Srinivas Bandi Ramesh Babu, Los Altos, CA (US); Srinivasa Rao Gurubelli, San Francisco, CA (US)

(73) Assignee: Harness Inc., San Francisco, CA (US)

(21) Appl. No.: 17/545,577

(22) Filed: Dec. 8, 2021

Related U.S. Application Data
(63) Continuation-in-part of application No. 17/371,127, filed on Jul. 9, 2021.

(51) Int. Cl. G06F 11/36

(52) U.S. Cl. CPC G06F 11/3664; G06F 11/3688

(57) ABSTRACT

A system that automatically reduces test cycle time to save resources and developer time. The present system selects a subset of tests from a full test plan that should be selected for a particular test cycle, rather than running the entire test plan. The subset of tests is intelligently selected using metrics such as tests associated with changed code and new and modified tests.

### CROSS REFERENCE TO RELATED APPLICATIONS

The present application claims the priority benefit of U.S. patent application Ser. No. 17/371,127, filed on Jul. 21, 2021, titled “TEST CYCLE TIME REDUCTION AND OPTIMIZATION,” the disclosure of which is incorporated herein by reference.

### BACKGROUND

Continuous integration of software involves integrating working copies of software into mainline software, in some cases several times a day. Before integrating the working copy of software, the working copy must be tested to ensure it operates as intended. Testing working copies of software can be time consuming, especially when following typical testing protocols which require executing an entire test plan every test cycle. An entire test plan often takes hours to complete, which wastes computing resources and developer time.

### SUMMARY

The present technology, roughly described, automatically reduces the time to a first failure in a series of tests. Detecting failures in tests, such as for example unit tests, allows engineers to assess and attend to any issues as soon as possible rather than once the unit tests are complete. The present system collects test data as unit tests are executed on code. The historical collection of data as well as details for the most recent source code under test are used to train a machine learnt model, for example one that uses gradient boosted decision trees. The trained models predict a likelihood of unit test failure for each unit test. The likelihood predictions are then used to order the test execution order so that the tests most likely to fail are executed first.

In operation, a test agent will operate in a testing environment and communicates with an intelligence server. When a test within the testing environment is about to execute, the test agent communicates with the intelligence server by providing the build number, commit-id, and other information, for example in one or more files sent by the test agent to the intelligence server. The intelligence server receives the information, processes the information using a call graph, and generates a test list. An artificial intelligence model is then trained with historical data for the and data for each current source code set to be tested. The training data may be modified to make it suitable for ingestion by the model. Once the model is trained, for each set, the model receives current data for each test unit and outputs a prediction of the likelihood that the particular test will failure. The system then orders the tests in order of mostly likely to fail to least likely to fail. The ordered tests are then executed in the determined order. When a test fails, an engineer can address the source code that is subject to the test, earlier rather than later due to the order of the unit tests, thereby saving engineer time and resources.

In some instances, the present technology provides a method for testing software. The method beings by detecting a test event initiated by a testing program and associated with testing a first software at a testing server, the test event detected by an agent executing within the testing program at the testing server, the testing event associated with a plurality of tests for the first software. The method continues by receiving, by the agent on the testing server from the remote server, a list of tests to be performed in response to the test event, the received list of tests being a subset of the plurality of tests. Each test in the list of tests is then ordered according to a likelihood of failure, and the ordered tests are executed by the agent in the testing server.

In some instances, a non-transitory computer readable storage medium includes embodied thereon a program, the program being executable by a processor to perform a method for automatically testing software code. The method may begin with detecting a test event initiated by a testing program and associated with testing a first software at a testing server, the test event detected by an agent executing within the testing program at the testing server, the testing event associated with a plurality of tests for the first software. The method continues by receiving, by the agent on the testing server from the remote server, a list of tests to be performed in response to the test event, the received list of tests being a subset of the plurality of tests. Each test in the list of tests is then ordered according to a likelihood of failure, and the ordered tests are executed by the agent in the testing server.

In some instances, a system for automatically testing software code includes a server having a memory and a processor. One or more modules can be stored in the memory and executed by the processor to detect a test event initiated by a testing program and associated with testing a first software at a testing server, the test event detected by an agent executing within the testing program at the testing server, the testing event associated with a plurality of tests for the first software, receive, by the agent on the testing server from the remote server, a list of tests to be performed in response to the test event, the received list of tests being a subset of the plurality of tests, order each test in the list of tests according to a likelihood of failure, and execute the ordered tests by the agent in the testing server

### BRIEF DESCRIPTION OF FIGURES

FIG. 1 is a block diagram of a system for testing software.

FIG. 2 is a block diagram of a testing agent.

FIG. 3 is a block diagram of an intelligence server.

FIG. 4 is a method for testing software.

FIG. 5 is a method for intelligently ordering tests in order of likelihood to fail.

FIG. 6 is a method for preparing and updating a prediction engine.

FIG. 7 is a table of a full set of methods and corresponding tests.

FIG. 8 is a table of a subset of methods and corresponding tests.

FIG. 9 is a table of tests for a subset of methods with corresponding likelihood of failure scores.

FIG. 10 is a table of tests for a subset of methods ordered based on likelihood of failure scores.

FIG. 11 is a block diagram of a computing environment for implementing the present technology.

### DETAILED DESCRIPTION

The present technology, roughly described, automatically reduces the time to a first failure in a series of tests. Receiving failures in tests, such as for example unit tests, allows engineers to assess and attend to any issues as soon as possible rather than once the unit tests are complete. The present system collects test data as unit tests are executed on code. The historical collection of data as well as details for the most recent source code under test are used to train a machine learnt model, for example one that uses gradient boosted decision trees. The trained models predict a likelihood of unit test failure for each unit test. The likelihood predictions are then used to order the test execution order so that the tests most likely to fail are executed first.

In operation, a test agent will operate in a testing environment and communicates with an intelligence server. When a test within the testing environment is about to execute, the test agent communicates with the intelligence server by providing the build number, commit-id, and other information, for example in one or more files sent by the test agent to the intelligence server. The intelligence server receives the information, processes the information using a call graph, and generates a test list. An artificial intelligence model is then trained with historical data for the and data for each current source code set to be tested. The training data may be modified to make it suitable for ingestion by the model. Once the model is trained, for each set, the model receives current data for each test unit and outputs a prediction of the likelihood that the particular test will failure. The system then orders the tests in order of mostly likely to fail to least likely to fail. The ordered tests are then executed in the determined order. When a test fails, an engineer can address the source code that is subject to the test, earlier rather than later due to the order of the unit tests, thereby saving engineer time and resources.

The present system addresses a technical problem of efficiently testing portions of software to be integrated into a main software system used by customers. Currently, when a portion of software is to be integrated into a main software system, a test plan is executed to test the entire test portion. The entire test plan includes many tests and takes a long time to complete, often hours, and takes up large amounts of processing and memory resources, as well as time.

The present system provides a technical solution to the technical problem of efficiently testing software by intelligently selecting a subset of tests from a test plan and executing the subset. The present system identifies portions of a system that have changed or for which a test has been changed or added, and adds the identified tests to a test list. An agent within the test environment then executes the identified tests. The portions of the system can be method classes, allowing for a very precise list of tests identified for execution.

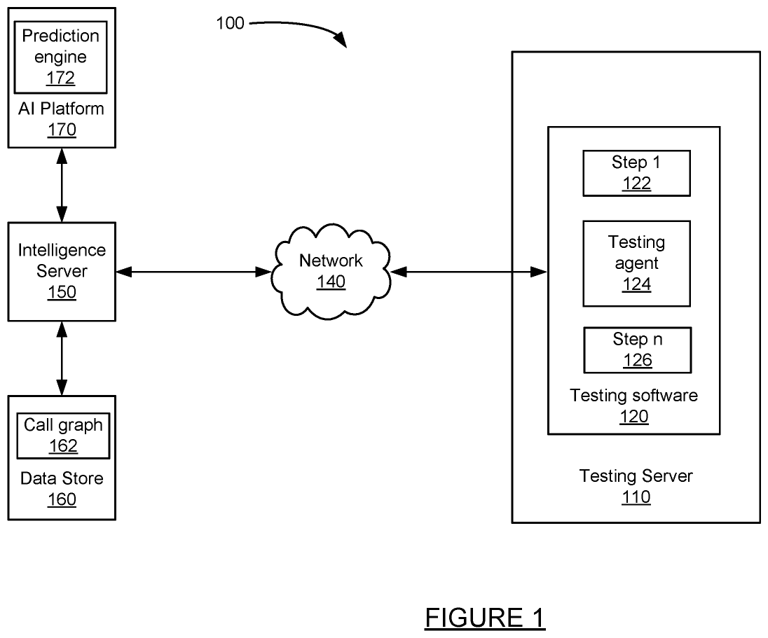

FIG. 1 is a block diagram of a system for testing software. System 100 of FIG. 1 testing server 110, network 140, intelligence server 150, data store 160, and artificial intelligence (AI) platform 170. Testing server 110, intelligence server 150, data store 160, may all communicate directly or indirectly with each other over network 140.

Network 140 may be implemented by one or more networks suitable for communication between electronic devices, including but not limited to a local area network, wide-area networks, private networks, public network, wired network, a wireless network, a Wi-Fi network, an intranet, the Internet, a cellular network, a plain old telephone service, and any combination of these networks.

Testing server 110 may include testing software 120. Testing software 120 tests software that is under development. The testing software can test the software under development in steps. For example, the testing software may test a first portion of the software using a first step 122, and so on with additional steps through an nth step 126.

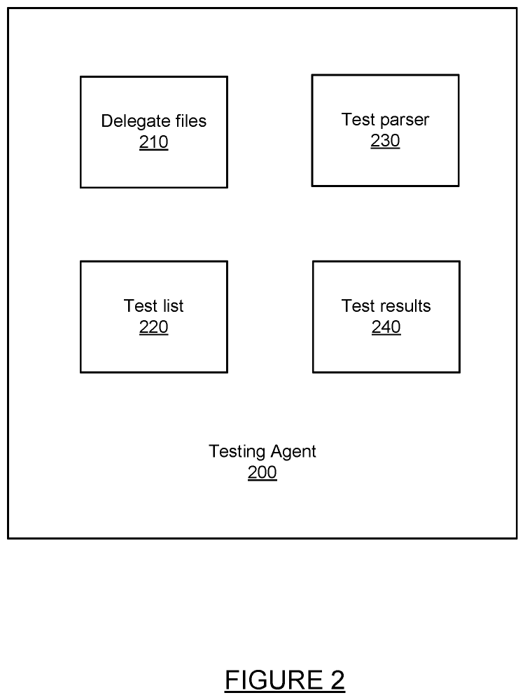

A testing agent 124 may execute within or in communication with the testing software 120. The testing agent may control testing for a particular stage or type of testing for the software being developed. In some instances, the testing agent may detect the start of the particular testing, and initiate a process to identify which tests of a test plan to execute in place of every test in the test plan. Testing agent 124 is discussed in more detail with respect to FIG. 2.

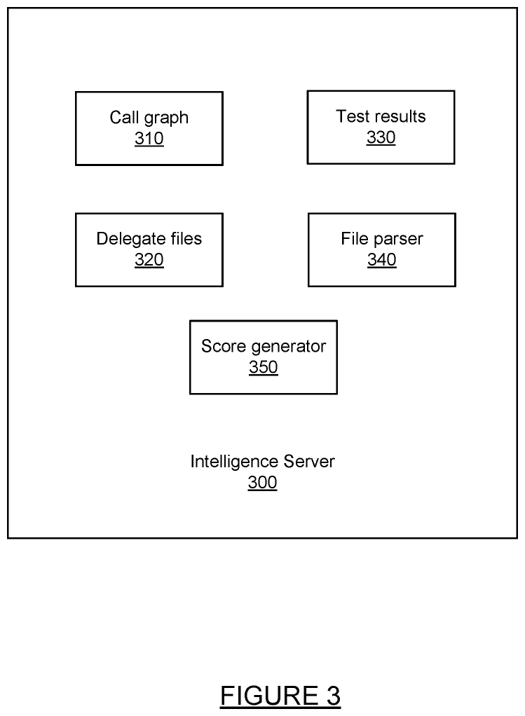

Intelligence server 150 may communicate with testing server 110 and data store 160, and may access a call graph stored in data store 160. Intelligence server 150 may identify a subgroup of tests for testing agent 124 to execute, providing for a more efficient testing experience at testing server 110. Intelligence server 150 may, in some instances, generate likelihood of failure scores and order tests in order of likelihood of failure. Intelligence server 150 is discussed in more detail with respect to FIG. 3.

Data store 160 may store a call graph 162 and may process queries for the call graph. The queries main include storing a call graph, retrieving call graph, updating portions of a call graph, retrieving data within the call graph, and other queries.

AI platform 170 may implement one or more artificial intelligence models that can be trained and applied to test data, current and historical, to predict the likelihood of failure for each test. The platform may implement a machine learning model that utilizes gradient boosted decision trees to predict the likelihood of a unit test failure. In some instances, the primary data are git-commit graphs of historical unit test results.

FIG. 2 is a block diagram of a testing agent. Testing agent 200 of FIG. 2 provides more detail of testing agent 120 of FIG. 1. Testing agent 200 includes delicate files 210, test list 220, test parser 230, and test results 240. Delegate files include files indicating what parts of a software under test have been updated or modified. These files can eventually be used to generate a subgroup of tests to perform on the software. Test list 220 is a list of tests to perform on the software being tested. The test list 220 may be retrieved from intelligence server 150 in response to providing the delegate files to the intelligence server. A test parser 230 parses files that have been tested to identify the methods and other data for each file. Test results 240 provide the results of a particular tests to indicate the test status, results, and other information.

FIG. 3 is a block diagram of an intelligence server. Intelligence server 300 of FIG. 3 provides more detail for intelligence server 150 of the system of FIG. 1. Intelligence server 300 includes call graph 310, delegate files 320, test results 330, file parser 340, and score generator 350. Call graph 310 is a graph having relationships between methods of the software under development, and subject to testing, and the tests to perform for each method. A call graph can be retrieved from the data store by the intelligence server. Delegate files are files are files within information regarding methods of interest in the software to be tested. Methods of interest include methods which have been changed, methods that have been added, and other methods. files can be received from the testing agent from the testing server. Test results 330 indicate the results of a particular set of tests. The test results can be received from a remote testing agent that is perform the tests. File parser 340 parses one or more delicate files received from a remote testing agent in order to determine which methods need to be tested.

An intelligence server can also include score generator 350. Score generator 350 can, in some implementations, implement one or more artificial intelligence models that can be trained and applied to test data, current and historical, to predict the likelihood of failure for each test. Hence, the artificial intelligence models of the present system can be implemented on intelligence server 150, AI platform 170, or both. Score generator 350 may implement a machine learning model that utilizes gradient boosted decision trees to predict the likelihood of a unit test failure. In some instances, the primary data are git-commit graphs of historical unit test results.

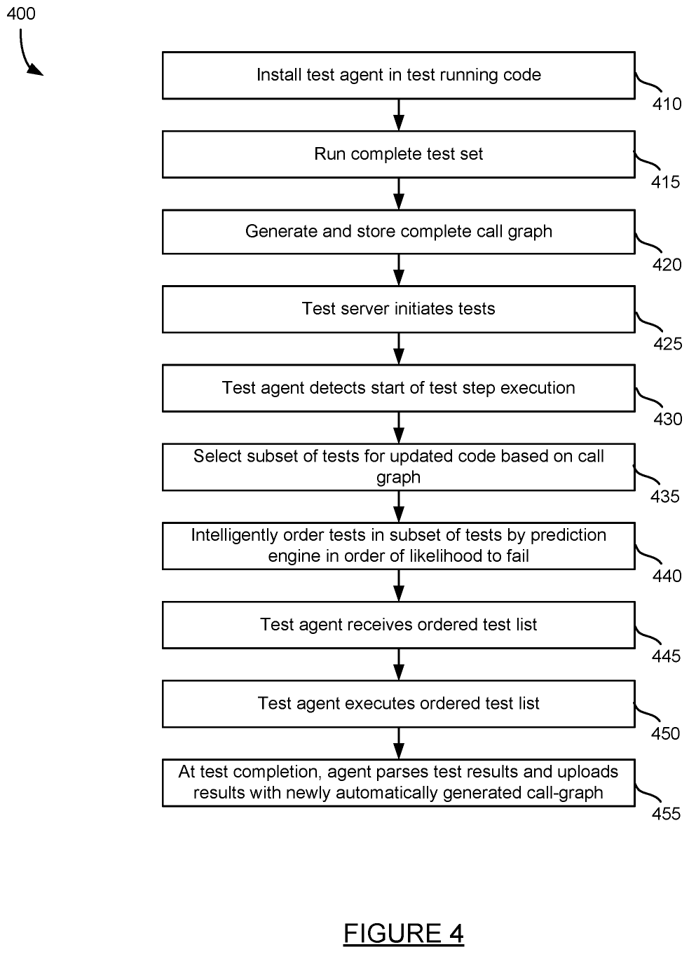

FIG. 4 is a method for testing software. First, a test agent is installed in testing software at step 410. The test agent may be installed in a portion of the testing software that performs a particular test, such as unit testing, in the software under development.

In some instances, the code to be tested is updated, or some other event occurs and is detected which triggers a test. A complete set of tests for the code may be executed at step 415.

A call graph may be generated with relationships between methods and tests, and stored at step 420. Generating a call graph may include detecting properties for the methods in the code. Detecting the properties may include retrieving method class information by an intelligence server based on files associated with the updated code. The call graph may be generated by the intelligence server and stored with the method class information by the intelligence server. The call graph may be stored on the intelligence server, a data store, or both.

In some instances, generating the call graph begins when the code to be tested is accessed by an agent on the testing server. Method class information is retrieved by the agent. The method class information may be retrieved in the form of one or more files associated with changes made to the software under test. The method class information, for example the files for the changes made to the code, are then transmitted by the agent to an intelligence server. The method class information is received by an intelligence server from the testing agent. The method class information is then stored either locally or at a data store by the intelligence server.

A test server initiates tests at step 425. The agent may detect the start of a particular step in the test at step 430. A subset of tests is then selected for the updated code based on the call graph generated by the intelligence server at step 435. Selecting a subset of tests may include accessing files associated by the changed code, parsing the received files to identify method classes associated with those files, and generating a test list from the received method classes using a call graph. Selecting a subset of tests for an updated code based on the call graph is disclosed in U.S. patent application Ser. No. 17/371,127, filed Jul. 9, 2021, titled “Test Cycle time Reduction and Optimization,” the disclosure of which is incorporated herein by reference.

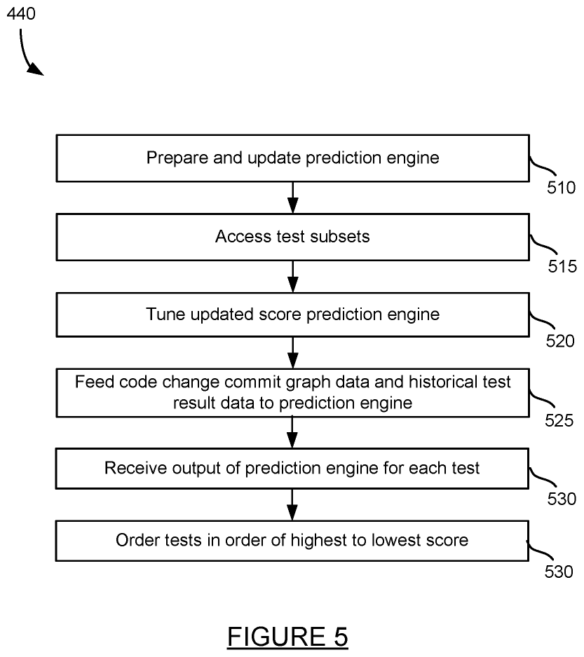

The tests in the subset of tests are intelligently ordered by a prediction engine in order of likelihood to fail at step 440. To intelligently order the tests, a likelihood of failure is predicted for each test. The prediction is made may by a prediction engine, implemented in some instances as a machine learning model utilizing gradient boosted decision trees. More detail for intelligently ordering tests is discussed with respect to the method of FIG. 5.

A test agent receives the ordered test list from the intelligence server at step 445. The test list is generated by the intelligence server and the AI model(s), which uses the call graph to select tests from a comprehensive test plan. The test list includes a subset of tests from the test plan that would normally be performed on the software under test, are and ordered based on likelihood for failure. The subset of tests only includes tests for methods that were changed and tests that have changed or added.

The test agent executes the ordered test list comprising the subset of tests at step 450. In some instances, a test agent executes the test list with instrumentation on. This allows data to be collected during the tests.

At test completion, the testing agent accesses and parses the test results and uploads the results with an automatically generated call graph at step 455. Parsing the test results may include looking for new methods as well as results of previous tests. The results may be uploaded to the intelligence server and include all or a new portion of a call graph or new information from which the intelligence server may generate a call graph. The intelligence server may then take the automatically generated call graph portion and place it within the appropriate position within a master call graph. The call graph is then updated, whether it is stored locally at the intelligence server or remotely on the data store.

FIG. 5 is a method for intelligently ordering tests in order of likelihood to fail. FIG. 5 provides more detail for step 440 of the method of FIG. 4. A prediction engine is prepared in updated at step 510. Pairing and updating the prediction engine may include training a machine learning model. The training may be done based on code change data in the form of command graphs and a score call unit test result data points. The code change data may include data such as who made a change to source code, the time of the source code change, the level of change made to the source code, and the files that were added or modified of the source code. The historical unit test result data points may include whether the tests have passed or failed, duration of tests, and the coverage of tests.

Test subsets are accessed at step 515. The subsets are the tests that have been determined will be tested in this test cycle. The score prediction engine may be tuned at step 520. Tuning the score prediction engine may be implemented with additional parameters. Some parameters that may tune a score generator engine include a learning rate, number of trees to use within the machine learning model, and the depth of the decisions.

Code change commit graph data and historical test result data are fed to the prediction engine at step 525. In some instances, the score generator can be implemented as a gradient boosted decision tree. A score can be in the form of a weight from 0 to 1, generated from the data that to the score generator. In this case, a score of 0.5 is a likelihood of failure, and less than 0.5 suggest there is a lower or no likelihood of failure.

The output of the prediction engine for each test is received at step 530. The tests are then ordered in order of highest predicted likelihood to fail to lowest predicted likelihood to fail.

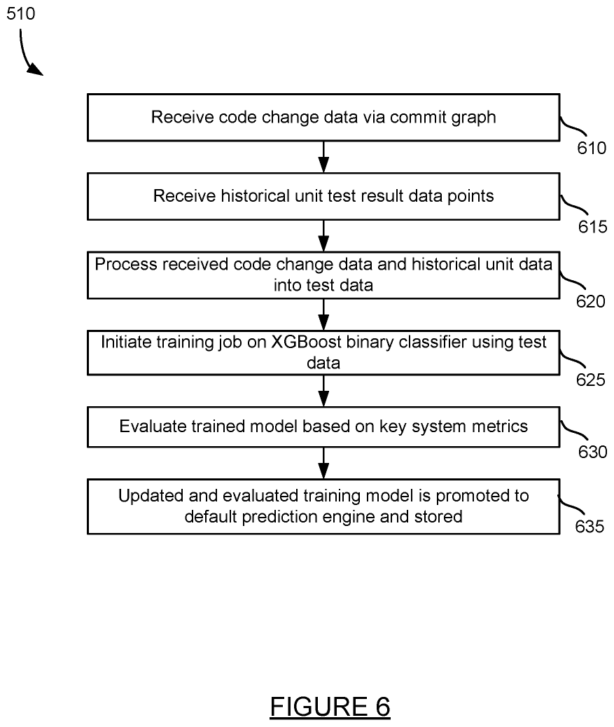

FIG. 6 is a method for preparing and updating a prediction engine. The method of FIG. 6 provides more detail for step 510 the method of FIG. 5. First, a code change data is received through a commit graph at step 610. Historical unit test result data points are received at step 615. The received code change data and historical unit data is processed into test data at step 620. The test data may have a format that allows data being to be ingested more easily by the machine learning models. A training job is initiated on an XG boost binary classifier using the test data at step 625 the trained model may be evaluated based on key system metrics at step 630. After training the model, the updated and evaluated training model is promoted to a default prediction engine and is stored at step 635. The updated and evaluated training model will be used to predict the likelihood of failure for each test.

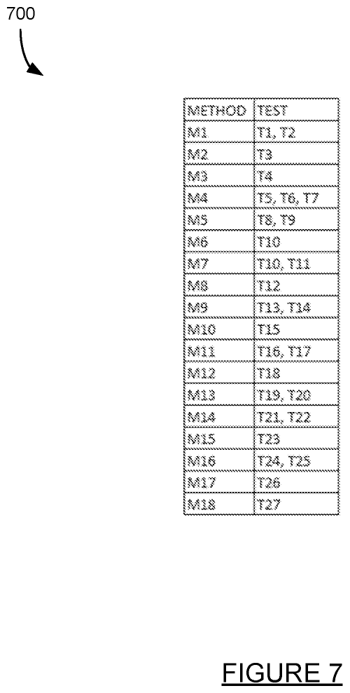

FIG. 7 is a table of a full set of methods and corresponding tests. Table 700 of FIG. 7 lists methods M1 through M 18. Each method may be included in a particular unit or block of software to be tested. For each method, one or more test is listed that should be performed for that particular method. For example, method M1 is associated with tests T1 and T2, method M2 is associated with test T3, and method M3 is associated with test T4. In typical systems, when there is a change detected in the software unit or block of software, the default test plan would include all the tests for methods M1-M18.

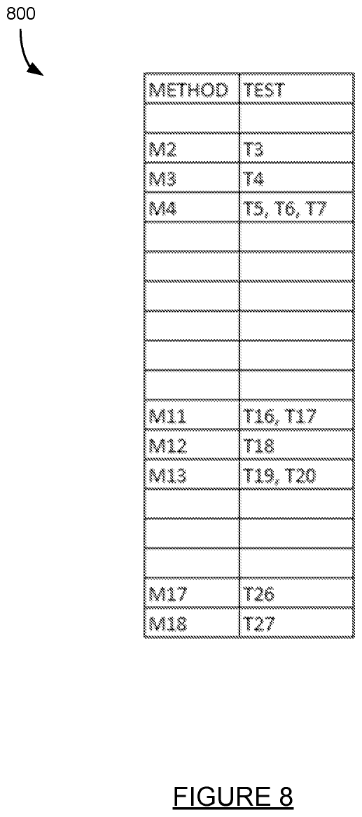

FIG. 8 is a table of a subset of methods and their corresponding tests. The subset of methods in table 800 corresponds to methods that have been detected to have changed or are associated with new or modified tests. The subset of methods illustrated in table 900 includes M2, M3, M4, M 11, M 12, M 13, M 17, and M 18. To identify the subset of methods, a list of methods that has been updated is transferred from the test agent to the intelligence server. The test agent may obtain one for more files associated with of updated method classes and transmit the files to the intelligence server. The agent may identify the files using a change tracking mechanism, which may be part of the agent or a separate software tool. The files are received by the intelligence server, and the intelligence server generates a list of methods from the files. In some instances, the list of methods includes methods listed in the files. The method list is then provided to the data store in which the call graph is stored. The data store then performs a search for tests that are related to the methods, based on the relationships listed in the call graphs. The list of tests is then returned to the intelligence server. The result is a subset of tests, which comprise fewer than all of the tests in a test plan that would otherwise be performed in response to a change in the software under test.

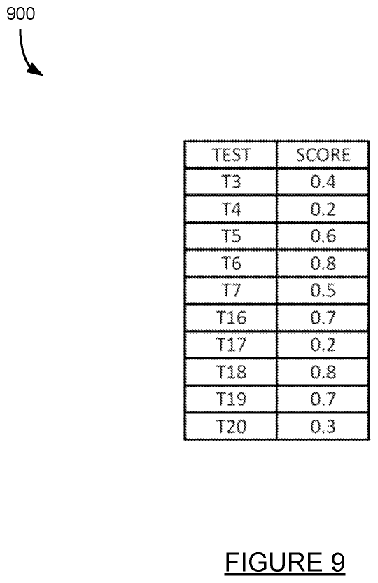

FIG. 9 is a table of tests for a subset of methods with corresponding likelihood of failure scores. The test IDs in the table of FIG. 9 are listed in numerical order. For each test ID, a score has been predicted. The score ranges from 0 to 1, and represents a prediction of the likelihood that a particular test will fail. For example, test T4 has a prediction score of 0.2 while T 16 has prediction score of 0.7. As such, T 16 is much more likely to fail than test T4.

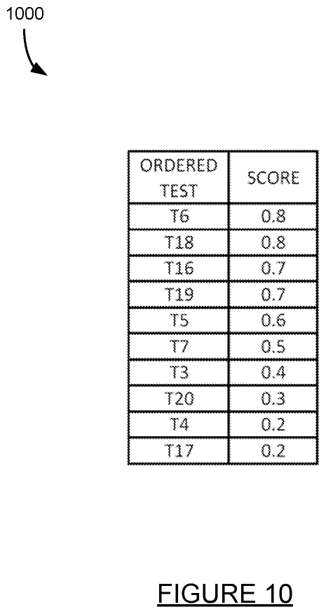

FIG. 10 is a table of tests for a subset of methods ordered based on likelihood of failure scores. Table 1000 of FIG. 10 list of tests ordered by the value of their corresponding score. For example, tests T6 and T 18 each have a score of 0.8, so they are the first tests ordered in the table. Test T 17 and T for each have a score of 0.2, so they are listed are ordered last in the table. The ordered test data is provided by intelligence server to a testing agent to execute the tests in the order of the value of the likelihood of failure score.

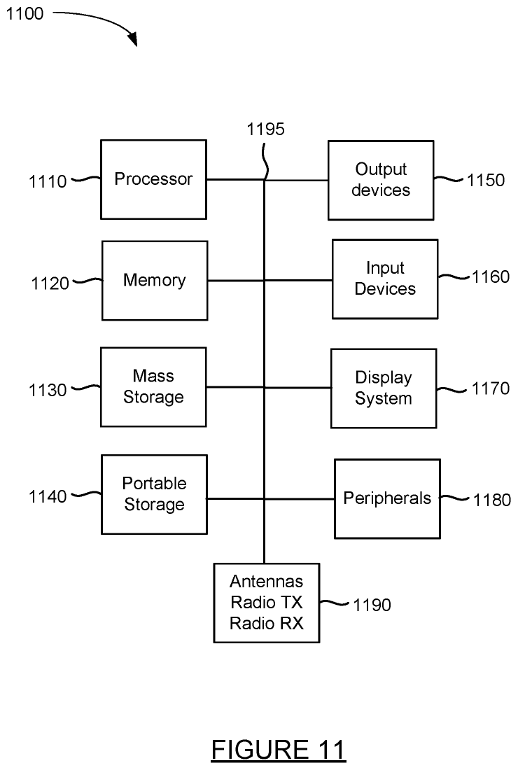

FIG. 11 is a block diagram of a system for implementing machines that implement the present technology. System 1100 of FIG. 11 may be implemented in the contexts of the likes of machines that implement testing server 110, intelligence server 150, and data store 160. The computing system 1100 of FIG. 11 includes one or more processors 1110 and memory 1120. Main memory 1120 stores, in part, instructions and data for execution by processor 1110. Main memory 1120 can store the executable code when in operation. The system 1100 of FIG. 11 further includes a mass storage device 1130, portable storage medium drive(s) 1140, output devices 1150, user input devices 1160, a graphics display 1170, and peripheral devices 1180.

The components shown in FIG. 11 are depicted as being connected via a single bus 1190. However, the components may be connected through one or more data transport means. For example, processor unit 1110 and main memory 1120 may be connected via a local microprocessor bus, and the mass storage device 1130, peripheral device(s) 1180, portable storage device 1140, and display system 1170 may be connected via one or more input/output (I/O) buses.

Mass storage device 1130, which may be implemented with a magnetic disk drive, an optical disk drive, a flash drive, or other device, is a non-volatile storage device for storing data and instructions for use by processor unit 1110. Mass storage device 1130 can store the system software for implementing embodiments of the present invention for purposes of loading that software into main memory 1120.

Portable storage device 1140 operates in conjunction with a portable non-volatile storage medium, such as a floppy disk, compact disk or Digital video disc, USB drive, memory card or stick, or other portable or removable memory, to input and output data and code to and from the computer system 1100 of FIG. 11. The system software for implementing embodiments of the present invention may be stored on such a portable medium and input to the computer system 1100 via the portable storage device 1140.

Input devices 1160 provide a portion of a user interface. Input devices 1160 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1100 as shown in FIG. 11 includes output devices 1150. Examples of suitable output devices include speakers, printers, network interfaces, and monitors.

Display system 1170 may include a liquid crystal display (LCD) or other suitable display device. Display system 1170 receives textual and graphical information and processes the information for output to the display device. Display system 1170 may also receive input as a touch-screen.

Peripherals 1180 may include any type of computer support device to add additional functionality to the computer system. For example, peripheral device(s) 1180 may include a modem or a router, printer, and other device.

The system of 1100 may also include, in some implementations, antennas, radio transmitters and radio receivers 1190. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1100 of FIG. 11 are those typically found in computer systems that may be suitable for use with embodiments of the present invention and are intended to represent a broad category of such computer components that are well known in the art. Thus, the computer system 1100 of FIG. 11 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically testing software code, comprising:
detecting a test event initiated by a testing program and associated with testing a first software at a testing server, the test event detected by an agent executing within the testing program at the testing server, the testing event associated with a plurality of tests for the first software;
receiving, by the agent on the testing server from the remote server, a list of tests to be performed in response to the test event, the received list of tests being a subset of the plurality of tests;
ordering each test in the list of tests according to a likelihood of failure; and
executing the ordered tests by the agent in the testing server.

2. The method of claim 1, further comprising generating, by a score generator, a likelihood of failure for each test, wherein the ordering is based on the likelihood of failure for each test.

3. The method of claim 1, wherein the score generator predicts the likelihood of failure based on historical data.

4. The method of claim 1, wherein the score generator predicts the likelihood of failure based on source code change data.

5. The method of claim 4, wherein the source code change data includes a source code change time, files that were added or modified to the source code, level of change made to the software, and who made the change to the source code.

6. The method of claim 1, wherein ordering each test includes:
training a score generator using training data associated with the source code being tested; and
applying test data to the trained score generator to generate the likelihood of failure for each test in the test list.

7. The method of claim 1, wherein the list of tests is generated based on a first call graph having relationships between the plurality of tests and portions of the first software, the duration of execution of the subset of tests in the test list is shorter than the duration of execution of the plurality of tests.

8. A non-transitory computer readable storage medium having embodied thereon a program, the program being executable by a processor to perform a method for automatically testing software code, the method comprising:
detecting a test event initiated by a testing program and associated with testing a first software at a testing server, the test event detected by an agent executing within the testing program at the testing server, the testing event associated with a plurality of tests for the first software;
receiving, by the agent on the testing server from the remote server, a list of tests to be performed in response to the test event, the received list of tests being a subset of the plurality of tests;
ordering each test in the list of tests according to a likelihood of failure; and
executing the ordered tests by the agent in the testing server.

9. The non-transitory computer readable storage medium of claim 8, further comprising generating, by a score generator, a likelihood of failure for each test, wherein the ordering is based on the likelihood of failure for each test.

10. The non-transitory computer readable storage medium of claim 8, wherein the score generator predicts the likelihood of failure based on historical data.

11. The non-transitory computer readable storage medium of claim 8, wherein the score generator predicts the likelihood of failure based on source code change data.

12. The non-transitory computer readable storage medium of claim 11, wherein the source code change data includes a source code change time, files that were added or modified to the source code, level of change made to the software, and who made the change to the source code.

13. The non-transitory computer readable storage medium of claim 8, wherein ordering each test includes:
training a score generator using training data associated with the source code being tested; and
applying test data to the trained score generator to generate the likelihood of failure for each test in the test list.

14. The non-transitory computer readable storage medium of claim 8, wherein the list of tests is generated based on a first call graph having relationships between the plurality of tests and portions of the first software, the duration of execution of the subset of tests in the test list is shorter than the duration of execution of the plurality of tests.

15. A system for automatically testing software code, comprising:
a server including a memory and a processor; and
one or more modules stored in the memory and executed by the processor to detect a test event initiated by a testing program and associated with testing a first software at a testing server, the test event detected by an agent executing within the testing program at the testing server, the testing event associated with a plurality of tests for the first software, receive, by the agent on the testing server from the remote server, a list of tests to be performed in response to the test event, the received list of tests being a subset of the plurality of tests, order each test in the list of tests according to a likelihood of failure, and execute the ordered tests by the agent in the testing server.

16. The system of claim 15, modules further executable to generate, by a score generator, a likelihood of failure for each test, wherein the ordering is based on the likelihood of failure for each test.

17. The system of claim 15, wherein the score generator predicts the likelihood of failure based on historical data.

18. The system of claim 15, wherein the score generator predicts the likelihood of failure based on source code change data.

19. The system of claim 18, wherein the source code change data includes a source code change time, files that were added or modified to the source code, level of change made to the software, and who made the change to the source code.

20. The method of claim 15, wherein ordering each test includes:
training a score generator using training data associated with the source code being tested; and
applying test data to the trained score generator to generate the likelihood of failure for each test in the test list.
